(19) United States
(12) Patent Application Publication
(10) Pub. No.: US 2013/0319803 A1
(43) Pub. Date: Dec. 5, 2013

(54) MAGNETIC SHOCK ABSORBING DEVICE

(71) Applicant: Tsung-Shih LEE, New Taipei City (TW)

(72) Inventor: Tsung-Shih LEE, New Taipei City (TW)

(21) Appl. No.: 13/486,935

(22) Filed: Jun. 1, 2012

(51) Int. Cl. F16F 7/00

(52) U.S. Cl. 188/267

(57) ABSTRACT

A magnetic shock absorbing device includes a cylinder and a magnetic module, and the magnetic module includes a plurality of magnetic units, and each magnetic unit includes a magnet, a protective cover covered onto the magnet, and an opening formed on both sides of each protective cover separately, and each magnetic unit is installed in series inside the cylinder, and a magnetic repulsive force is formed between sides of any two of the adjacent magnetic units, and the magnetic repulsive force produced by each magnetic unit in the magnetic module is used for producing a damping force to achieve a shock absorbing effect.

### FIELD OF THE INVENTION

The present invention relates to a shock absorbing device, in particular to a magnetic shock absorbing device.

### BACKGROUND OF THE INVENTION

Shock absorbing devices are used extensively in different fields including cars, motorcycles and chairs, etc. In general, a shock absorbing device is installed in a car or a motorcycle to reduce vibrations produced by the car or the motorcycle driven on rough road surfaces, and the shock absorbing device is intended for passengers and drivers in the car or on the motorcycle to avoid bumpy rides and provide a stable and comfortable ride for both passengers and drivers. When applied to a support base of a chair, the shock absorbing device can alleviate impact forces when a user sits on the chair, so as to prevent the user from getting vertebral injuries when the user is sitting on the chair in a quick manner. Further, the shock absorbing device can improve the comfortability of the chair, so that the user will not feel uncomfortable even after sitting on the chair for a long time. Meanwhile, a good design of the shock absorbing device can absorb small vibrations to meet functional requirements and maintain good balance and stability.

In general, a conventional shock absorbing device comprises a cylinder, a piston and a spring, and the piston and the spring are installed inside the cylinder to partition the cylinder into a chamber A and another chamber B, and the chamber A of the cylinder contains a working fluid which can be air or liquid, and the periphery of the cylinder is sealed to prevent the working fluid from being deteriorated or leaking, and the piston has at least one penetrating hole, such that if an external force is exerted on the shock absorbing device, the piston will be driven to compress the working fluid to flow from the chamber A to the chamber B through the penetrating hole, so as to produce a damping force to offset the external force and achieve the damping or shock absorbing effect. After the external force diminishes, the piston is pulled by the spring back to its original position and returns the working fluid in the chamber B to the chamber A.

However, the conventional shock absorbing device still has the following drawbacks: 1. Forces exerted on the area of the spring are uneven. 2. After the piston is operated together with the working fluid, the conventional shock absorbing device cannot provide different damping forces to meet the requirements of different external forces, so that the shock absorbing effect of the shock absorbing device is usually low. 3. The conventional shock absorbing device comes with a complicated structure and a large volume, thus wasting both manufacturing and material costs and also requires a relatively difficult assembling process, thus incurring more manufacturing and assembling time and cost. 4. If the working fluid is the liquid, the piston will be restored slowly, and thus failing to make a quick and sensitive response to different compression depths and different intensities of the external force. 5. If the working fluid is the air, the compression ratio is nonlinear, so that when the intensity of the external force reaches a certain level, the air will not be compressed by the piston easily. On the other hand, a reaction force is produced, and thus the link rod connected to the piston may be damaged. Obviously, the conventional shock absorbing device requires improvements.

### SUMMARY OF THE INVENTION

Therefore, it is a primary objective of the present invention to provide a magnetic shock absorbing device that uses a magnetic repulsive force produced by each magnet inside the magnetic module to produce a damping force in order to achieve a shock absorbing effect.

To achieve the foregoing objective, the present invention provides a magnetic shock absorbing device comprising a cylinder and a magnetic module, wherein the magnetic module includes a plurality of magnetic units, and each magnetic unit includes a magnet, a protective covert covered onto the magnet, and an opening formed on both sides of each protective cover separately, and each magnetic unit is installed in series inside the cylinder, and a magnetic repulsive force is formed between sides of any two of the adjacent magnetic units.

To achieve the foregoing objective, the present invention further provides a magnetic shock absorbing device comprising a first cylinder, a first magnetic module, a second cylinder and a second magnetic module, wherein the first magnetic module includes a plurality of first magnetic units, and each first magnetic unit includes a first magnet, a first protective cover covered onto the first magnet, and an opening formed on both sides of each first protective cover separately, and each first magnetic unit is installed in series inside the first cylinder, and a first magnetic repulsive force is formed between sides of any two of the adjacent first magnetic units, and the second cylinder is stacked and coupled to the first cylinder, and the second magnetic unit includes a second magnet and a second protective cover, and the second protective cover is covered onto the exterior of the second magnet, and the second protective cover includes an open slot formed on a lateral of the second protective cover and a distal opening formed on both sides of the second protective cover separately, and the second magnetic unit is installed in the second cylinder, and a first magnetic adhesive force is formed between a lateral of the second magnetic unit and the second cylinder, and a second magnetic repulsive force is formed between the second magnetic unit and each first magnetic unit.

The present invention has the following advantages and effects: 1. The present invention comes with a design capable of maintaining good balance and stability. 2. The present invention has a simple structure and a small volume and thus saves manufacturing time and manufacturing and material costs. 3. The number of magnetic units in the cylinder can be increased or decreased according to different external forces, applications or occasions, or the magnetic shock absorbing devices can be stacked and coupled to assemble an appropriate length of the magnetic shock absorbing device for different occasions. 4. The shock absorbing device of the invention comes with a quick and sensitive response and will not produce reaction forces in an opposite direction, so as to provide a safe and stable application. 5. The magnets have no issue of being elastically fatigue, and thus the shock absorbing device of the invention has a long service life. 6. Since the cylinder contains no working fluid, therefore it is not necessary to seal the cylinder to prevent the working fluid from being deteriorated or leaking, so as to enhance the safety of the use. 7. The invention makes use of the feature of the partial adhesive force to achieve a better shock absorbing effect and reinforce the shock absorbing function.

### BRIEF DESCRIPTION OF THE DRAWINGS

FIG. 1 is an exploded view of a first preferred embodiment of the present invention;

FIG. 2 is a cross-sectional view of the first preferred embodiment of the present invention;

FIG. 3 is a schematic view of an application of the first preferred embodiment of the present invention;

FIG. 4 is an exploded view of a second preferred embodiment of the present invention;

FIG. 5 is a perspective view of the second preferred embodiment of the present invention;

FIG. 6 is a cross-sectional view of the second preferred embodiment of the present invention;

FIG. 7 is a first schematic view of an application of the second preferred embodiment of the present invention;

FIG. 8 is a second schematic view of an application of the second preferred embodiment of the present invention;

FIG. 9 is an exploded view of a third preferred embodiment of the present invention;

FIG. 10 is a cross-sectional view of the third preferred embodiment of the present invention;

FIG. 11 is an exploded view of a fourth preferred embodiment of the present invention; and

FIG. 12 is a cross-sectional view of the fourth preferred embodiment of the present invention.

### DESCRIPTION OF THE PREFERRED EMBODIMENTS

The details and technical contents of the present invention will become apparent with the description of the following preferred embodiments accompanied with the illustration of the related drawings as follows. However, the drawings are provided for reference and for the purpose of illustrating the present invention only, but not intended for limiting the scope of the invention.

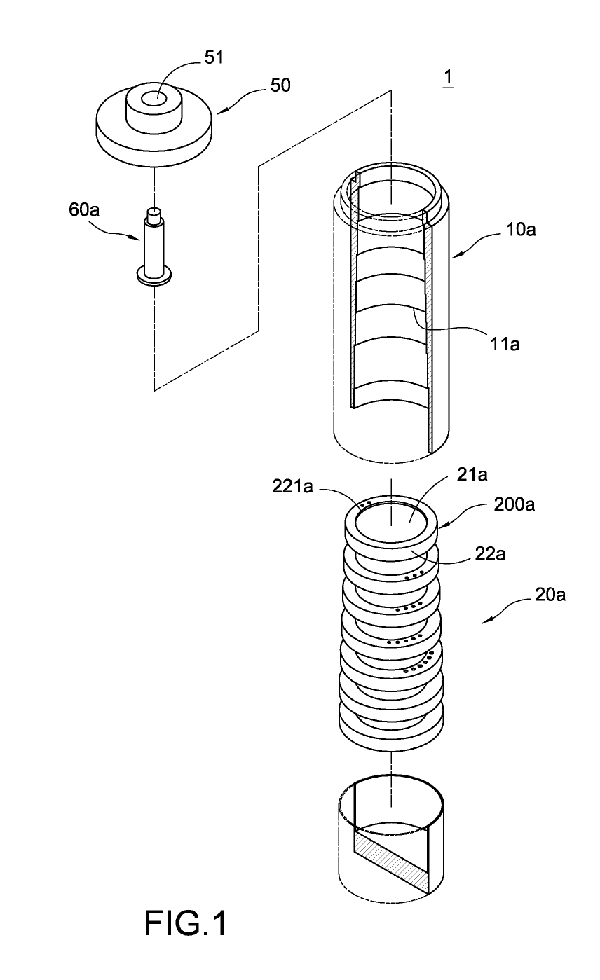

With reference to FIG. 1 for an exploded view of a first preferred embodiment of the present invention, the present invention provides a magnetic shock absorbing device 1 comprising a cylinder 10a and a magnetic module 20a.

The cylinder 10a is made of a plastic, metal or composite material, and the cylinder 10a can be in a cylindrical shape, a square columnar shape, a hexagonal columnar shape or a pentagonal columnar shape, but the invention is not limited to such arrangement only. In addition, the cylinder 10a contains a plurality of stepped slots 11a of different sizes.

The magnetic module 20a includes a plurality of magnetic units 200a, and each magnetic unit 200a includes a magnet 21a and a protective cover 22a, and each protective cover 22a is covered onto each respective magnet 21a, and an opening 221a is formed on both sides of each protective cover 22a separately, and each magnetic unit 200a is installed in series inside the cylinder 10a, and same polar sides (S-S, N-N) of the magnets 21a are aligned towards one another to form a magnetic repulsive force A between sides of any two adjacent magnetic units 200a, and each magnetic unit 200a is contained in each corresponding stepped slot 11a. The protective cover 22a is made of a magnetically insulative material, but the invention is not limited to such arrangement only. A gap C is maintained between each protective cover 22a and an inner wall of the cylinder 10a. Further, when bearing an external force W, the magnetic module 20a has a buffer displacement X.

The magnetic shock absorbing device 1 further comprises a lid 50 and a rod 60a, wherein the lid 50 is covered onto the corresponding cylinder 10a, and the lid 50 is made of plastic, and the lid 50 has a penetrating hole 51, and an end of the rod 60a is passed into and coupled to the penetrating hole 51 and abutted against a distal surface of one of the magnetic units 200a.

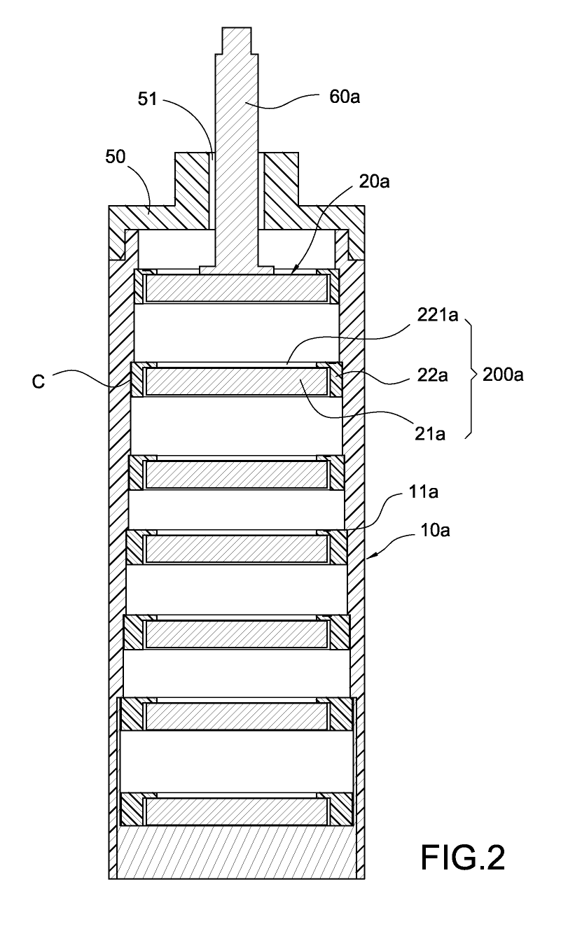

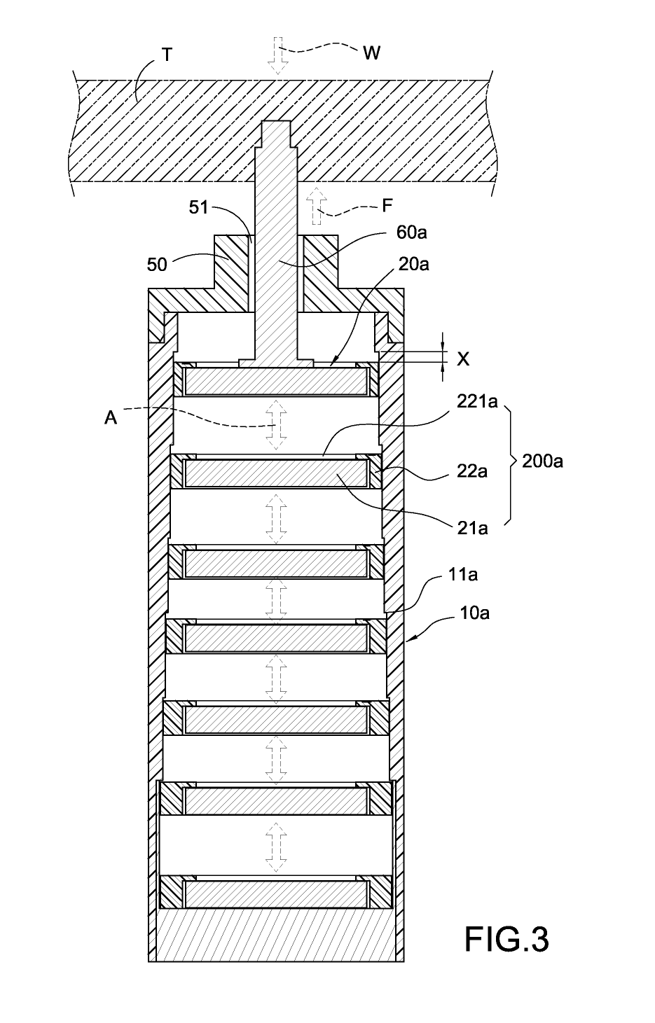

With reference to FIGS. 2 and 3 for a cross-sectional view and a schematic view of an application in accordance with the first preferred embodiment of the present invention respectively, the magnetic module 20a is placed in the cylinder 10a, and then an end of the rod 60a is passed into and coupled to the penetrating hole 51, and the lid 50 is covered onto the corresponding cylinder 10a, and finally an end of the rod 60a away from the lid 50 is coupled to a support base T of a chair.

If a user sits on the chair or applies other forces to the support base T, then an external force W is exerted onto the support base T to move the rod 60a downward, so that the rod 60a can transmit the external force W to abut against the magnetic unit 200a of rod 60a and transmit the external force W to the whole magnetic module 20a. In the meantime, a magnetic repulsive force A produced between the magnets 21a will produce a damping force F in an opposite direction of the external force W to offset the external force W, so as to achieve the shock reducing and absorbing functions.

Therefore, the quantity of magnetic units 200a in the cylinder 10a can be increased or decreased according to different external forces W, uses or occasions to achieve the most appropriate shock absorbing effect. In addition, the magnetic shock absorbing device 1 comes with a simple structure and a small volume, and thus saving manufacturing time and manufacturing and material costs. Further, the magnet 21a does not have an elastically fatigue issue, and thus the shock absorbing device 1 has a long service life. Since the cylinder 10a contains no working fluid, so that it is not necessary to prevent the working fluid from being deteriorated or leaking. The cylinder 10a is simply seal to improve the safety of use.

In addition, the protective cover 22a can prevent an excessive external force W to produce a too-large buffer displacement X between the magnets 21a, and collisions occur between the magnets 21a and may damage or break each magnet 21a.

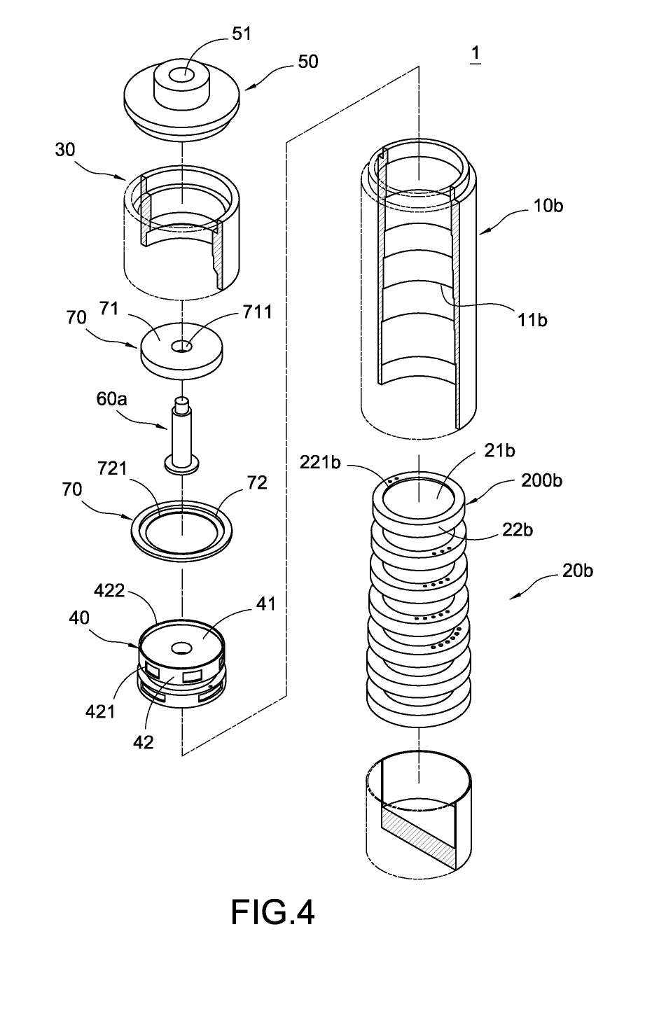

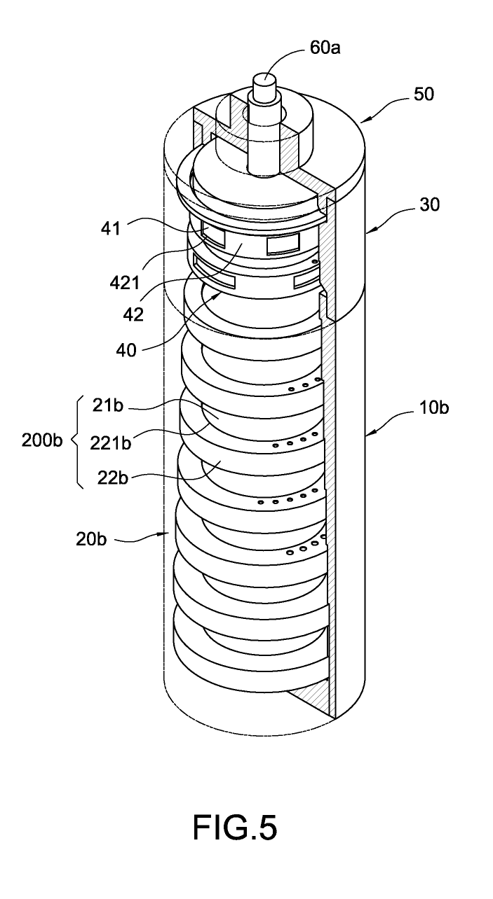

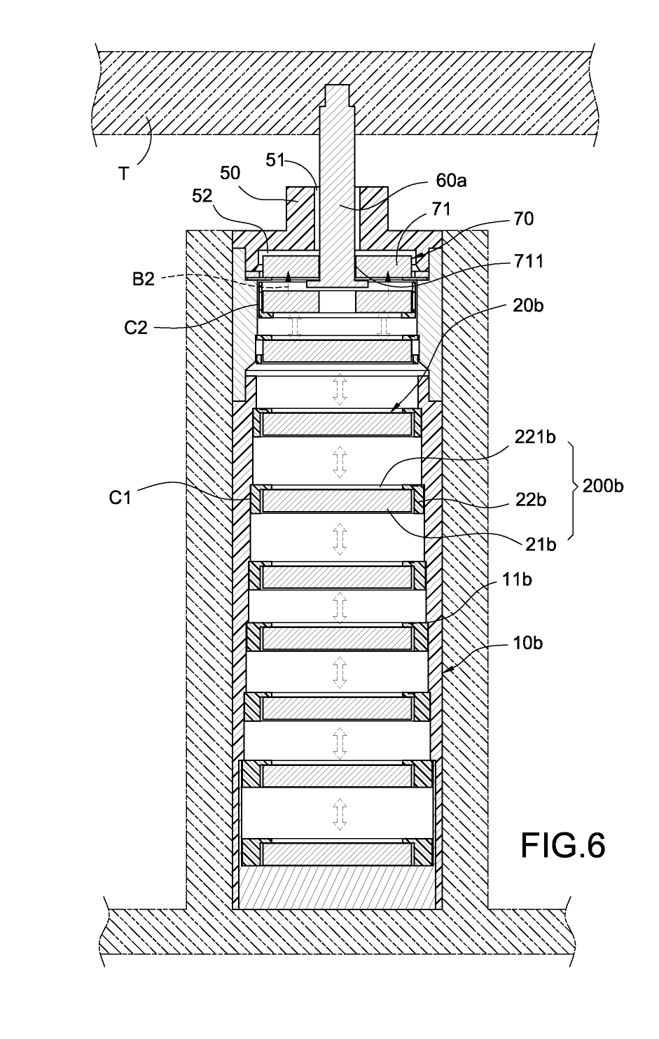

With reference to FIGS. 4 to 6 for an exploded view, a perspective view and a cross-sectional view of the second preferred embodiment of the present invention respectively, the difference of this preferred embodiment from the previous preferred embodiment resides on that the magnetic shock absorbing device 1 comprises a first cylinder 10b, a first magnetic module 20b, a second cylinder 30 and at least one second magnetic unit 40.

The first cylinder 10b is made of plastic, metal or composite material, but the present invention is not limited to these materials only, and the first cylinder 10b is in a cylindrical shape, a square columnar shape, a hexagonal columnar shape or a pentagonal columnar shape, but the present invention is not limited to these shapes only. In addition, the first cylinder 10b includes a plurality of stepped slots 11b of different sizes formed in the first cylinder 10b.

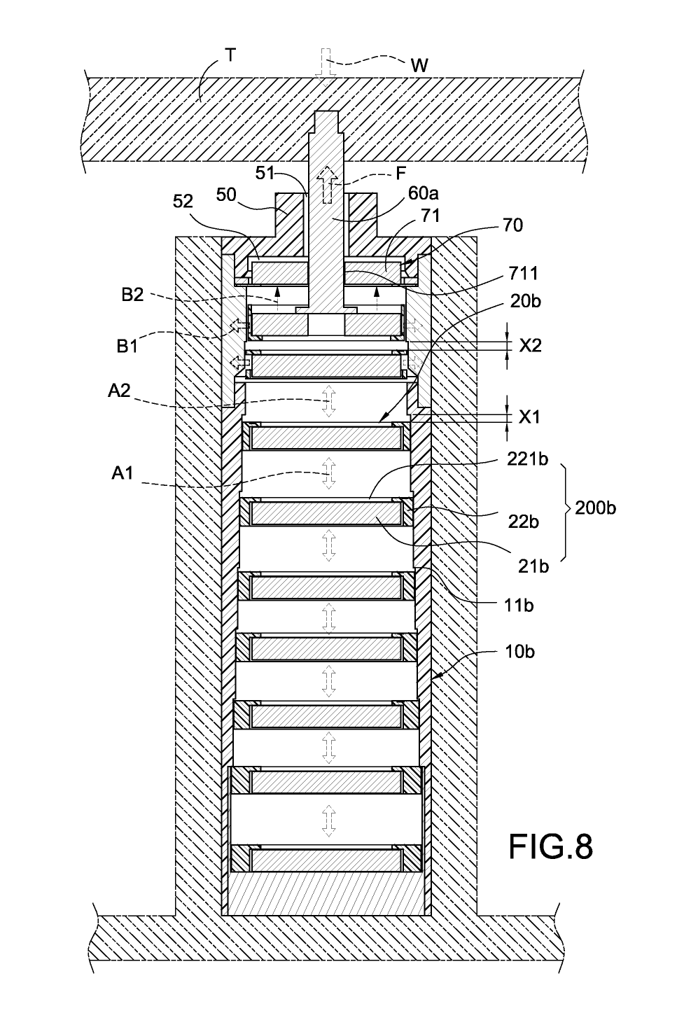

The first magnetic module 20b includes a plurality of first magnetic units 200b, and each first magnetic unit 200b includes a first magnet 21b and a first protective cover 22b, wherein each first protective cover 22b is covered onto each corresponding first magnet 21b, and an opening 221b is formed on both sides of each of the first protective covers 22b, and each first magnetic unit 200b is installed in series inside the first cylinder 10b, and each first magnetic unit 200b is contained in each corresponding stepped slot 11b, and same polarity sides (S-S, N-N) of the first magnets 21b are aligned towards one another to form a first magnetic repulsive force A1 between sides of any two of the adjacent first magnetic units 200b, and a gap C1 is maintained between each first protective cover 22b and an inner wall of the first cylinder 10b, such that when the first magnetic module 20b bears an external force W (as shown in FIG. 8), the first magnetic module 20b has a buffer displacement X₁ (as shown in FIG. 8). In addition, the first protective cover 22b is made of a magnetically insulative material, but the present invention is not limited to this material only.

The second cylinder 30 is stacked and coupled to the corresponding first cylinder 10b, and the second cylinder 30 is made of metal and in an shape such as a cylindrical shape, a square columnar shape, a hexagonal columnar shape or a pentagonal columnar shape, but a distal opening of the second cylinder 30 stacked and coupled to the corresponding first cylinder 10b has a shape of the corresponding first cylinder 10b.

The second magnetic unit 40 includes a second magnet 41 and a second protective cover 42, and the second protective cover 42 is covered onto the exterior of the second magnet 41, and the second protective cover 42 has an open slot 421 formed on a lateral of the second protective cover 42 and a distal opening 422 formed on both sides of the second protective cover separately, and the second magnetic unit 40 is installed in the second cylinder 30, and a first magnetic adhesive force B1 is formed between a lateral of the second magnetic unit 40 and the second cylinder 30 (as shown in FIG. 8), and a second magnetic repulsive force A2 is formed between the second magnetic unit 40 and each first magnetic unit 200b, and a gap C2 is maintained between the second protective cover 42 and the inner wall of the second cylinder 30, such that when the second magnetic unit 40 bears the gravitational force, the second magnet unit 40 has a buffer displacement X₂ (as shown in FIG. 8). Further, the second protective cover 42 is made of a magnetically insulative material, but the present invention is not limited to this material only.

The magnetic shock absorbing device 1 further comprises a lid 50, a rod 60a and a third magnetic unit 70, wherein the lid 50 is made of plastic, and the lid 50 is covered onto the corresponding second cylinder 30, and the lid 50 has a penetrating hole 51 and a containing space 52, and the penetrating hole 51 is interconnected to the containing space 52, and the third magnetic unit 70 is installed in the containing space 52.

The third magnetic unit 70 includes a third magnet 71 and a third protective cover 72, wherein the third protective cover 72 is covered onto the corresponding third magnet 71, and an opening 721 is formed at the bottom of the third protective cover 72, and a second magnetic adhesive force B2 is formed between the third magnetic unit 70 and the second magnetic unit 40. The third magnet 71 has a through hole 711, and an end of the rod 60a is passed into and coupled to the penetrating hole 51 and the through hole 711 and abutted against a distal surface of the second magnetic unit 40. In addition, the third protective cover 72 is made of a magnetically insulative material, but the present invention is not limited to this material only.

During an assembling process, the first magnetic module 20b is put into the first cylinder 10b, and then the second cylinder 30 is stacked and coupled to the corresponding first cylinder 10b; the second magnetic unit 40 is put into the second cylinder 30; and the third magnetic unit 70 is put into the lid 50. After an end of the rod 60a is passed into and coupled to the penetrating hole 51 and the through hole 711, the lid 50 is covered onto the corresponding second cylinder 30, and finally an end of the rod 60a away from the lid 50 is coupled to the support base T.

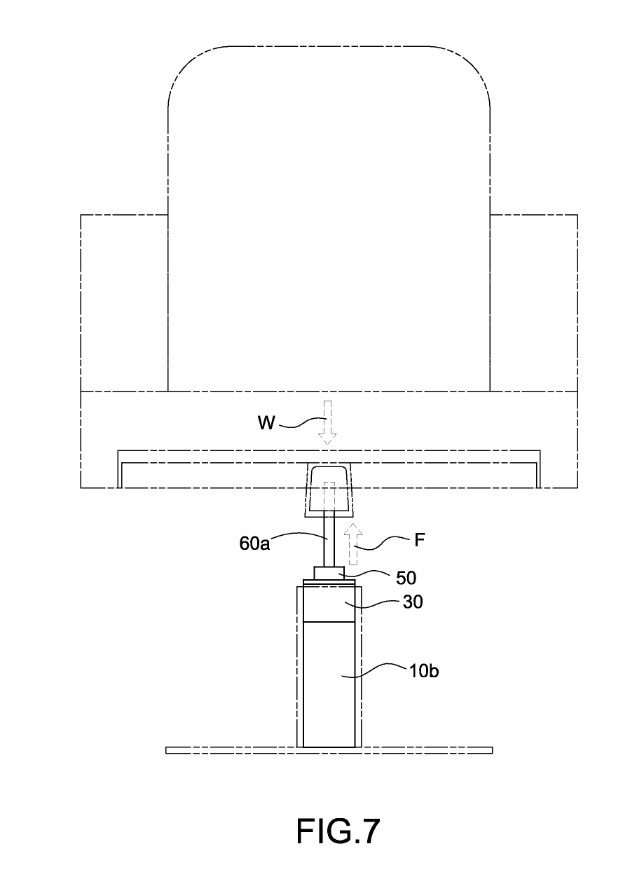

With reference to FIGS. 7 and 8 for first and second schematic views of applications of the second preferred embodiment of the present invention, when a user sits on a chair, the first magnetic adhesive force B1 between the two magnetic units 40 and the second cylinder 30 offsets the external force W to achieve a first-stage shock absorbing effect, and then the remaining external force W is transmitted to the first magnetic module 20b, and the first magnetic repulsive force A1 produced between the first magnetic units 200b offsets the remaining external force W to achieve a second-stage shock absorbing effects, so as to achieve the two-stage shock reducing and absorbing functions. Therefore, the feature of a partial adhesive force is used to achieve a better shock absorbing effect and reinforce the shock absorbing function.

In addition, the magnetic shock absorber has a sensitive response and will not produce a reaction in an opposite direction, so as to achieve the stability of use, so that when the user sits on the chair, the user's body receives a too-large damping force F of the magnetic shock absorbing device 1 to cause injuries or discomfort to the user and improve the comfort of sitting on the chair, so as to achieve the effect of preventing the user from being injured.

In addition, after the external force W diminishes, the second magnetic unit 40 will produce a buffer displacement X₂ by the external force W, and the second magnetic adhesive force B2 produced between the third magnetic unit 70 and the second magnetic unit 40 will attract and return the second magnetic unit 40 to its original position. In the meantime, the second magnetic repulsive force A2 produced between the second magnetic unit 40 and the first magnetic unit 200b will push the second magnetic unit 40 to its original position to assure the effect of reducing and absorbing shocks of the external force W for the next time, and thus the invention can provide the function repeatedly.

Besides, the first protective cover 22b and the second protective cover 42 can prevent a too-large downwardly pressed external force W, so that each first magnet 21b and each second magnet 41 will be collided with one another due to the too-large buffer displacements X₁, X₂. As a result, the first magnet 21b and the second magnet 41 may be damaged or broken easily.

The third protective cover 72 also prevents the third magnetic unit 70 and the second magnetic unit 40 from being collided with one another due to the too-large second magnetic adhesive force B2 between the third magnetic unit 70 and the second magnetic unit 40 after the downwardly pressed external force W diminishes. As a result, the third magnet 71 and the second magnet 41 may be damaged or broken easily.

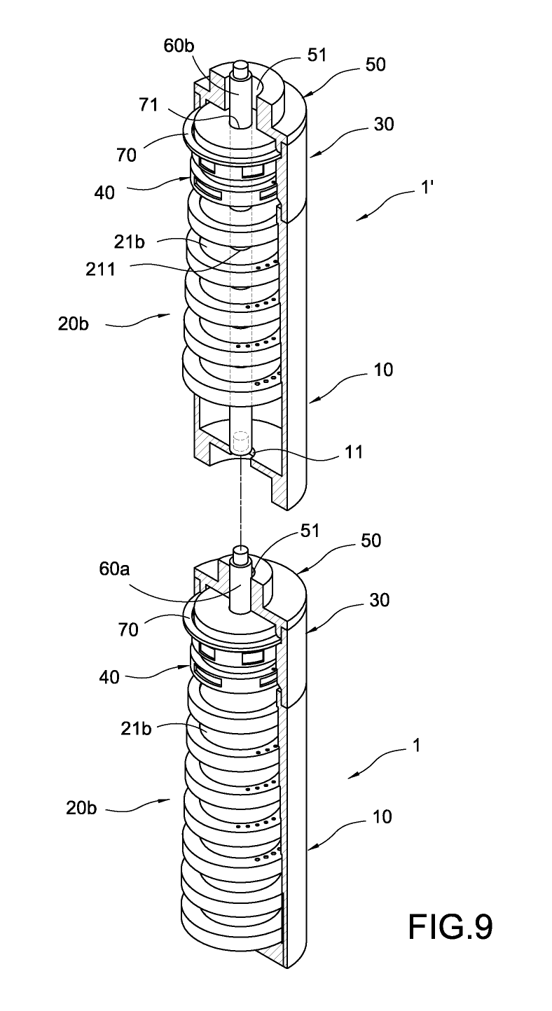

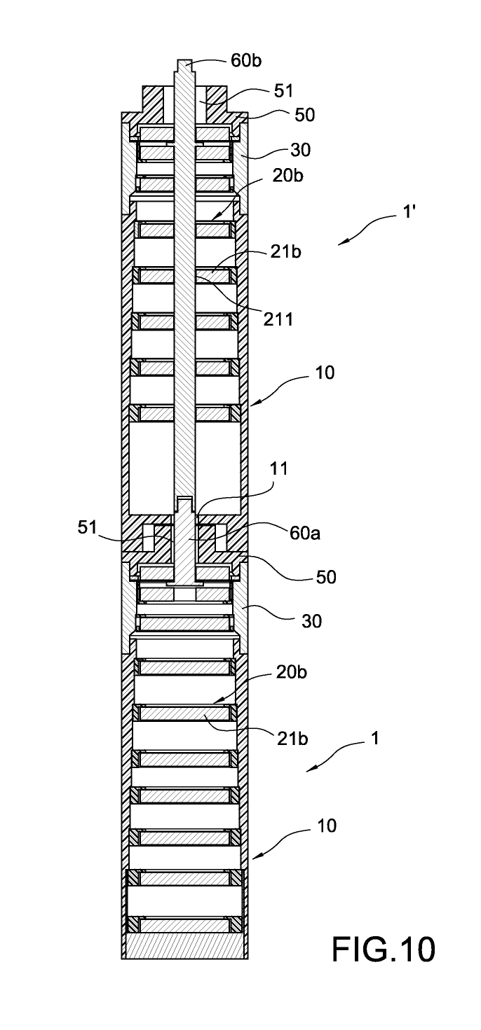

With reference to FIGS. 9 and 10 for an exploded view and a cross-sectional view of the third preferred embodiment of the present invention respectively, the difference of this preferred embodiment from the previous preferred embodiments resides on that the magnetic shock absorbing devices 1, 1′ can be stacked and coupled to each other, wherein the magnetic shock absorbing device 1′ is stacked and coupled to the magnetic shock absorbing device 1, and the rod 60a of the magnetic shock absorbing device 1′ is changed to a rod 60b, and each first magnet 21b of the first magnetic module 20b has a first penetrating hole 211 and a second penetrating hole 12 formed at the bottom of the first cylinder 10b, and the rod 60b is passed and coupled to the penetrating hole 51 of the lid 50, the through hole 711 of the third magnet 71, the first penetrating hole 211 of each first magnet 21b, and the second penetrating hole 12 of the first cylinder 10b, and a distal surface of the rod 60b is coupled to the rod 60a of the magnetic shock absorbing device 1.

Besides of providing a better effect of the damping force F and the shock absorption, the magnetic shock absorbing devices can be connected to an appropriate length to fit different occasions,

With the multi-stage shock reducing and absorbing functions, smaller vibrations can be absorbed to improve the balance and stability of the shock absorption.

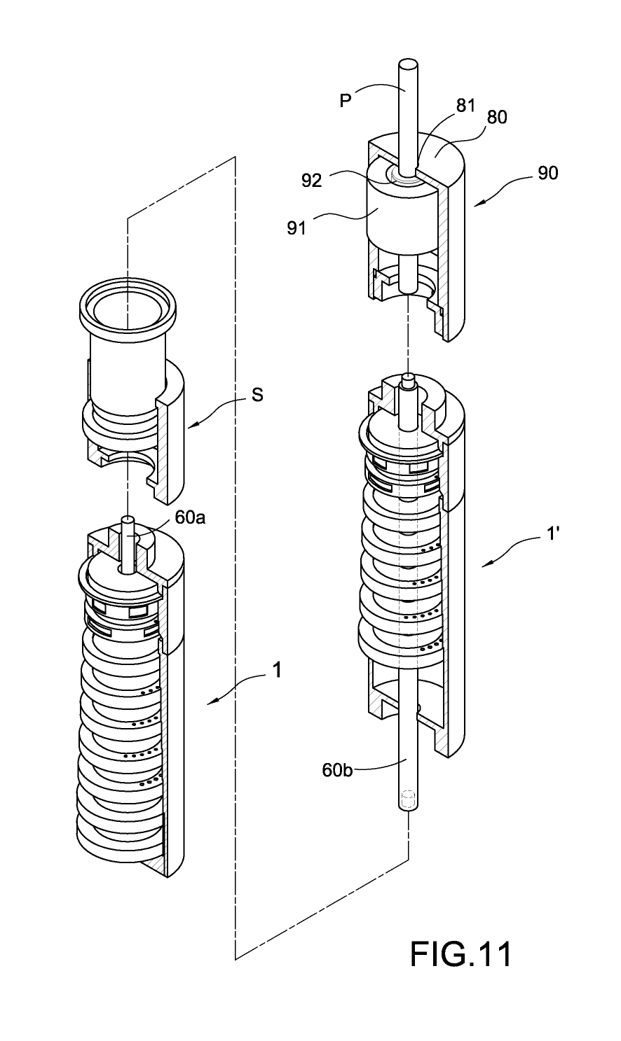

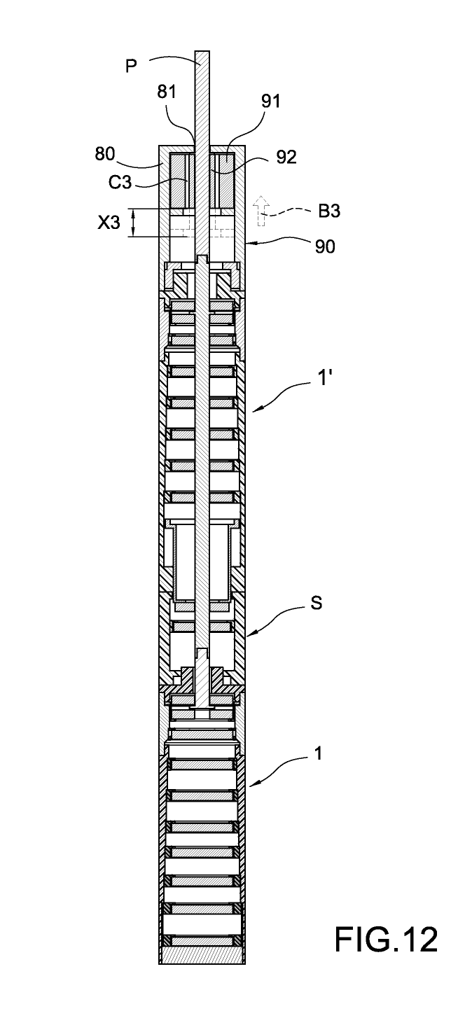

With reference to FIGS. 11 and 12 for an exploded view and a cross-sectional view of the fourth preferred embodiment of the present invention, the difference of this preferred embodiment from the previous preferred embodiments resides on that the magnetic shock absorbing device 1′ further comprises a third cylinder 80, a fourth magnetic module 90, a fastener S and a connecting rod P, wherein the magnetic shock absorbing device 1 and the magnetic shock absorbing device 1′ are coupled to both ends of the fastener S respectively, and the third cylinder 80 is stacked and coupled to the corresponding second cylinder 30, and the third cylinder 80 is made of plastic, and the third cylinder 80 has a penetrating hole 81, and the third cylinder 80 is in a cylindrical shape, a square columnar shape, a hexagonal columnar shape or a pentagonal columnar shape. However, the third cylinder 80 of the invention is not limited to these shapes only, and it can be any other shape corresponding to the shape of the second cylinder 30.

The fourth magnetic module 90 is contained in the third cylinder 80, and the fourth magnetic module 90 includes an outer circular pillar magnet 91 and an inner circular pillar magnet 92, wherein the outer circular pillar magnet 91 is covered onto an external surface of the inner circular pillar magnet 92, and the outer surface of the outer circular pillar magnet 91 is coupled to an inner wall of the third cylinder 80, and a gap C3 is formed between the inner surface of the outer circular pillar magnet 91 and the outer surface of the inner circular pillar magnet 92, so that when the inner circular pillar magnet 92 bears an external force W, the inner circular pillar magnet 92 has a buffer displacement X3, and a third magnetic adhesive force B3 is formed between the outer circular pillar magnet 91 and the inner circular pillar magnet 92, and the fourth magnetic module 90 has a cross-section substantially in a concentric circular shape.

An end of the connecting rod P is passed into and coupled to the penetrating hole 81 and fixed to the inner circular pillar magnet 92 and coupled to the rod 60b or the rod 60a, and the rod 60b is passed and coupled to the fastener S, and an end of the rod 60b is coupled to the rod 60a. Since the length of the rod 60b is too long, the rod 60b can be passed and coupled to the fastener S to prevent bending or warping the rod 60b, and the third magnetic adhesive force B3 between the outer circular pillar magnet 91 and the inner circular pillar magnet 92 is used to further improve the effect of the damping force F, so as to achieve a multi-stage shock reducing function. Besides providing better shock reducing and absorbing effects, the shock absorbing device of the present invention also comes with better balance and stability, such that the user can sit on a chair more comfortably.

In addition, when the magnetic shock absorbing device 1′ bears a larger external force W, and one or all of the buffer displacements X₁, X₂ reach a maximum displacement stroke, the fastener S assures the rod 60b to transmit the external force W to the magnetic shock absorbing device 1 to guarantee that the damping force F in the magnetic shock absorbing device 1 has exerted its effect to achieve a better shock absorbing effect and provide the best design that can maintain the smoothest and force-eliminating effect and reduce the load.

In summation of the description above, the present invention improves over the prior art and complies with patent application requirements, and thus is duly filed for patent application. While the invention has been described by means of specific embodiments, numerous modifications and variations could be made thereto by those skilled in the art without departing from the scope and spirit of the invention set forth in the claims.

What is claimed is:

1. A magnetic shock absorbing device, comprising:
a cylinder; and
a magnetic module, including a plurality of magnetic units, and each magnetic unit including a magnet, a protective cover covered onto the magnet, and an opening formed on both sides of each protective cover separately, and each magnetic unit being installed in series inside the cylinder to form a magnetic repulsive force between two sides of any two of the adjacent magnetic units.

2. The magnetic shock absorbing device of claim 1, further comprising a lid covered onto the corresponding cylinder, and the cylinder including a plurality of stepped slots of different sizes formed therein, and each magnetic unit being installed in each corresponding stepped slot.

3. The magnetic shock absorbing device of claim 2, further comprising a rod, and the lid includes a penetrating hole, and an end of the rod being passed into and coupled to the penetrating hole and abutted against an end surface of one of the magnetic units.

4. A magnetic shock absorbing device, comprising:
a first cylinder; and
a first magnetic module, including a plurality of first magnetic units, each of the first magnetic units including a first magnet, a first protective cover covered onto the first magnet, and an opening formed on both sides of each protective cover separately, and each first magnetic unit being installed in series inside the first cylinder to form a magnetic repulsive force between two sides of any two of the adjacent first magnetic units;
a second cylinder, stacked and coupled to the first cylinder; and
a second magnetic unit, including a second magnet, a second protective cover covered onto the exterior of the second magnet, an open slot formed on a lateral of the second protective cover, and a distal opening formed on both sides of the second magnetic unit, and the second magnetic unit being installed inside the second cylinder to form a first magnetic adhesive force between the lateral of the second magnetic unit and the second cylinder, and a second magnetic repulsive force at the side between the second magnetic unit and the adjacent first magnetic unit.

5. The magnetic shock absorbing device of claim 4, wherein the first cylinder includes a plurality of stepped slots of different sized therein, and each first magnetic unit is installed at each corresponding stepped slot.

6. The magnetic shock absorbing device of claim 4, further comprising a lid and a third magnetic unit, and the lid being covered onto the corresponding second cylinder, and the lid having a containing space for installing the third magnetic unit therein, and the third magnetic unit including a third magnet and a third protective cover, and the third protective cover being covered onto the corresponding third magnet, and the third protective cover having an opening formed at the bottom of the third protective cover, and a second magnetic adhesive force is formed between the third magnetic unit and the second magnetic unit.

7. The magnetic shock absorbing device of claim 6, further comprising a rod, and the lid having a penetrating hole, and the third magnet having a through hole, and an end of the rod being passed and coupled to the penetrating hole and the through hole and abutted against a distal surface of the second magnetic unit.

8. The magnetic shock absorbing device of claim 7, further comprising a third cylinder and a fourth magnetic module stacked and coupled to the corresponding second cylinder, and the fourth magnetic module being installed in the third cylinder.

9. The magnetic shock absorbing device of claim 8, wherein the fourth magnetic module includes an outer circular pillar magnet and an inner circular pillar magnet, and the outer circular pillar magnet is covered onto the inner circular pillar magnet, and an outer surface of the outer circular pillar magnet is coupled to an inner wall of the third cylinder, and a gap is formed between an inner surface of the outer circular pillar magnet and an outer surface of the inner circular pillar magnet, and a third magnetic adhesive force is formed between the outer circular pillar magnet and the inner circular pillar magnet.

10. The magnetic shock absorbing device of claim 9, further comprising a connecting rod, and the third cylinder having a penetrating hole, and an end of the connecting rod being passed and coupled to the penetrating hole, fixed to the inner circular pillar magnet, and coupled to the rod.
